(19) United States
(12) Patent Application Publication
(10) Pub. No.: US 2004/0208554 A1
(43) Pub. Date: Oct. 21, 2004

(54) Packet/TDM integrated node apparatus

(76) Inventors: Junnosuke Wakai, Yokohama (JP); Hirofumi Masukawa, Isehara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/201,961

(22) Filed: Jul. 25, 2002

(30) Foreign Application Priority Data
Mar. 6, 2002 (JP) P2002-060231

(51) Int. Cl. H04J 4/00; H04J 14/00; H04J 14/08

(52) U.S. Cl. 398/54

(57) ABSTRACT

To realize both conventional TDM-based communication typically provided by SONET and packet-based communication typically provided by Ethernet on a same optical transmission path, an integrated packet and TDM switching node apparatus is offered. This node apparatus receives wavelength-division-multiplexed optical signals of a plurality of channels incoming through a first optical transmission path and transmits wavelength-division-multiplexed optical signals of a plurality of channels over a second optical transmission path. The node apparatus comprises packet Framers, TDM Framers, and means for allocating optical signals of different wavelengths to the TDM Framers and packet Framers and wavelength division multiplexes TDM frame transmission channels and packet frame transmission channels on a same optical transmission path.

### BACKGROUND OF THE INVENTION

(1) Field of the Invention

The present invention relates to a node apparatus for use in an optical network and, more particularly, to an integrated packet and TDM switching node apparatus that makes packet transmission compatible with TDM transmission on the same optical network.

(2) Description of Related Art

One of backbone network architecture for communications carriers and Internet Service Providers (ISPs) is an optical ring network configuration using a Synchronous Optical Network (SONET) Add Drop Multiplexer (ADM) that adopted Synchronous Digital Hierarchy (SDH). The SONET is network technology based on Time Division Multiplex (TDM) which the carriers have applied for long years. The SONET was developed to transmit voice traffic and traffic over leased lines at high speed. Currently, not only voice traffic and traffic over leased lines, but also data packet traffic such as IP packets is multiplexed in SONET frames.

FIG. 2 shows a configuration example of a TDM (SONET) ring that is a conventional backbone network.

The TDM (SONET) ring comprises a plurality of nodes of SONET ADMs 10-1 to 10-3, connected in rings with two optical transmission paths 11. Each node has high-speed interfaces for connection to the optical transmission paths 11 and low-speed interfaces for connection to a TDM network 2 (2A or 2B) and a packet network 3 (3A or 3B). The TDM network 2 includes a PBX 5 (5A or 5B) and a data processing system for banking online system or the like 6 (6A or 6B) that requires high-speed communication. The packet network 3 includes a router 7 (7A or 7B) via which computers are connected to the network.

The backbone TDM ring network supports ring network formations such as Bidirectional Line Switched Ring (BLSR) and Unidirectional Path Switched Ring (UPSR). These network formations use two optical fibers connecting nodes; one is active for transmitting traffic and the other is standby for transmitting backup traffic, wherein the direction of transmission over one path is opposite to the direction of transmission over the other path. Thereby, highly reliable network operation can be achieved, and such networks are mainstream public communications networks.

Along with explosive increase of data packet traffic due to recent development of the Internet, network technology for transmitting packets more efficiently than the above-mentioned SONET that is TDM-based transmission technology is under study. The IEEE and other various forums are discussing the standardization of such network technology.

For example, 10G Ethernet featuring a higher data transmission rate of up to 10 Gb/sec has been introduced as a new version of the Ethernet (a registered trademark) which is typical packet-based network technology developed in the LAN domain. The 10G Ethernet is expected to provide a backbone ring of a network that is even larger than LAN such as MAN/WAN. The 10G Ethernet is currently under discussion at IEEE 802.3ae and scheduled to be standardized on March 2002.

A Resilient Packet Ring (RPR) is a ring network for high-speed transmission of MAC-layer packets with their format extended from the Ethernet frame. The RPR is provided with the functions of packet congestion control, network topology detection, and protection, and attracts attention as the key technology of the next generation backbone networks. The RPR is currently under discussion at IEEE 802.17 and scheduled to be standardized on March 2003.

These high-speed packet transmission techniques are actively discussed at RPR Alliance, 10G Ethernet Alliance, and Metro Ethernet Forum as well. As data packet traffic is expected to continue to increase in future, it is anticipated that the conventional TDM-based network architecture as the backbone network will change to new packet-based network architecture, such as RPR and 10G Ethernet.

TDM-based networks such as SONET are considered remaining as they have run so far even when the above-mentioned new packet-based networks will have been used commonly in future. This is because the packet-based high-speed networks which are newly provided are intended to enhance the efficiency of transmitting variable-length packets, but it is difficult for these networks to support high-quality TDM transmission functions that the conventional TDM-based networks have.

For example, in the SONET, the techniques for preventing or reducing transmission delay, preventing or reducing jitter and wander, and protection have been established, which are indispensable for high-quality communications services such as voice transmission over telephone circuits and data transmission for online transactions via leased lines.

Because the SONET is based on time division multiplex/demultiplex technique in which data is transmitted in time slots that are sequenced at even intervals of time, delay of data transmitted on a same channel hardly occurs. The SONET standards prescribe the detailed specifications of jitter and wander tolerances over transmission paths and in node apparatus. The manufacturers of TDM nodes design node apparatus to conform to the SONET standards, and, therefore, jitter and wander of signals to be transmitted through the TDM nodes are very small.

The SONET adopts high-speed switching technique called Automatic Protection Switching (APS) as protection technique, which requires redundant communication paths to be configured, so that communication path recovery can quickly be performed in the event of failure occurring. In packet-based networks, however, these techniques for preventing or reducing transmission delay, preventing or reducing jitter and wander, and protection are not established.

Attempts to design a node by uniting packet-based high-speed network technology and TDM-based network technology are confronted by many problems.

For example, a RPR node inserts a packet into a transmission frame (Add) on the ring and extracts a packet from the transmission frame (Drop) arbitrarily, which is not compatible with the TDM technology requiring synchronous manipulation. According to the specifications of WAN-PHY which is one version of 10G Ethernet, the payload of a SONET frame shall contain an Ethernet frame only. The WAN-PHY cannot support TDM technology allowing for dividing a SONET frame into a plurality of VC frames.

Consequently, it is anticipated that high-speed packet nodes for RPR and 10G Ethernet (hereinafter referred to as RPR/Ethernet nodes) are provided as nodes for packet transmission only, independent of SONET ADM functions. Probably, actual network topology will be, for example, as is shown in FIG. 3 where a new RPR/Ethernet ring 16 is constructed separately from the existing TDM ring 11.

RPR/Ethernet nodes 15-1 to 15-3 are connected to the RPR Ethernet ring network 16 through their high-speed line interfaces and connected to, for example, packet networks 3A, 3B and routers 7A, 7B through their low-speed line interfaces.

The RPR/Ethernet ring network 16 consists of optical fibers 17 (17-1 to 17-3) which form an outer ring and optical fibers 18 (18-1 to 18-3) which form an inner ring. The outer ring 17 is primarily used for data packet transmission and the inner ring 18 is primarily used as a transmission path for control packets. The direction of data transmission over the outer ring shall be opposite to the direction of data transmission over the inner ring. In the event of failure of either ring occurring, signaling between the nodes by control packets is performed for recovery from the failure, so that highly reliable network operation can be carried out.

The network architecture of the RPR/Ethernet nodes 15 is analogous to BLSR and UPSR in a TDM ring, but different from that of SONET ADMs. The RPR Ethernet nodes are not connected to PBXs 5 and banking systems 6 which are included in TDM networks 2, respectively.

As described above, the exiting TDM network and an RPR/Ethernet network which is newly provided are physically similar in architecture, but completely different from a logical point of view. Thus, it is difficult to realize a node having both TDM functionality and RPR/Ethernet functionality. When RPR/Ethernet nodes will be put into practical use, such a network topology is anticipated that a TDM network comprising SONET ADMs and a packet network comprising RPR/Ethernet nodes exist separately as shown in FIG. 3. A problem is posed that duplex network management is required.

### SUMMARY OF THE INVENTION

It is an object of the present invention to provide a communications network making it to realize both conventional TDM-based communication typically provided by SONET and packet-based communication typically provided by RPR/Ethernet on a same optical transmission path.

It is another object of the present invention to provide a new communications node apparatus having both conventional TDM-based communication functions typically provided by SONET and packet-based communication functions typically provided by RPR/Ethernet.

It is yet another object of the present invention to provide a new communications node apparatus capable of selectively multiplexing TDM-based communication channels and packet-based communication channels on a same network.

It is a further object of the present invention to provide an integrated packet and TDM switching node apparatus capable of dynamical switching of a part or all of TDM-based communication channels multiplexed on a network to packet-based communication channels if necessary.

It is a still further object of the present invention to provide an integrated packet and TDM switching node apparatus capable of dynamical switching of a part or all of packet-based communication channels multiplexed on a network to TDM-based communication channels if necessary.

In order to achieve the foregoing objects, a node apparatus according to the present invention has two communication functions of packet transmission mode and TDM transmission mode and is able to configure one physical transmission line to serve for a packet transmission network and a TDM transmission network.

The present invention provides an integrated packet and TDM switching node apparatus. This node apparatus receives wavelength-division-multiplexed optical signals of a plurality of channels incoming through a first optical transmission path and transmits wavelength-division-multiplexed optical signals of a plurality of channels over a second optical transmission path. The node apparatus comprises at least one TDM Framer, at least one packet Framer, and means for allocating optical signals of different wavelengths to the TDM Framer and packet Framer. The node apparatus wavelength division multiplexes TDM frame transmission channels and packet frame transmission channels on the first and second optical transmission paths.

More specifically, the node apparatus of the present invention includes optical signal circuitry which receives wavelength-division-multiplexed optical signals of a plurality of channels incoming through a first optical transmission path, converts the optical signals into electrical signals, and outputs the electrical signals to a plurality of per-channel receive ports, while converting electrical signals received from a plurality of per-channel transmit ports into wavelength-division-multiplexed optical signals of a plurality of channels and transmitting these wavelength-division-multiplexed optical signals over a second optical transmission path. The above-mentioned TDM Framer and packet Framer are connected to separate transmit/receive ports of the optical signal circuitry for different channels.

In a preferred embodiment of the present invention, the node apparatus includes a plurality of TDM Framers, a TDM switching unit for switching TDM data from the plurality of TDM Framers to a TDM network and vice versa, a plurality of packet Framers, and a packet router for switching packets from the plurality of packet Framers to a packet network and vice versa. The plurality of TDM Framers and packet Framers are connected to separate transmit/receive ports of the optical signal circuitry for different channels.

The integrated packet and TDM switching node apparatus according to the present invention can be applied as an ADM node for connecting a packet network and a TDM network which operate at relatively low speed to a high-speed network formed by first and second optical rings, wherein the direction of signal transmission over the first optical ring is opposite to the direction of signal transmission over the second optical ring.

According to the present invention, the node apparatus includes selectors for selectively connecting one of the TDM Framers or one of the packet Framers to each of a plurality of pairs of transmit/receive ports of the optical signal circuitry. The selectors are controlled by a control unit to change the connections between the transmit/receive ports and the TDM Framers as well as the packet Framers if necessary. Thus, the number of channels operating in TDM transmission mode and the number of channels operating in packet transmission mode can be changed at any time if necessary.

The node apparatus also includes means for monitoring packet traffic passing across the packet router and TDM traffic passing across the TDM switching unit. By controlling the selectors, based on traffic data collected by these monitoring means, transmission mode switchover on a per-channel basis can be implemented flexibly, according to traffic variation.

### BRIEF DESCRIPTION OF THE DRAWINGS

The invention will be more particularly described with reference to the accompanying drawings, in which:

FIG. 1 shows one network configuration example to which integrated packet and TDM switching nodes according to the present invention are applied;

FIG. 2 shows a configuration example of a TDM ring that is a conventional backbone network;

FIG. 3 shows a network topology example in which a ring network comprising high-speed packet nodes and an existing TDM ring coexist;

FIG. 4 shows another network configuration example to which integrated packet and TDM switching nodes according to the present invention are applied;

FIG. 5 is a structural block diagram showing one embodiment of an integrated packet and TDM switching node according to the present invention;

FIG. 6 is a block diagram showing the detailed structure of an optical line interface shown in FIG. 5;

FIG. 7 is a block diagram showing the detailed structure of an IP packet router shown in FIG. 5;

FIG. 8 is a block diagram showing the detailed structure of a TDM switching unit shown in FIG. 5;

FIG. 9 is a diagram for explaining a stack of protocols which are applied to an integrated packet and TDM switching node of the present invention;

FIG. 10 is a diagram for explaining another example of a stack of protocols which are applied to an integrated packet and TDM switching node of the present invention; and

FIG. 11 shows yet another network configuration example to which integrated packet and TDM switching nodes according to the present invention are applied.

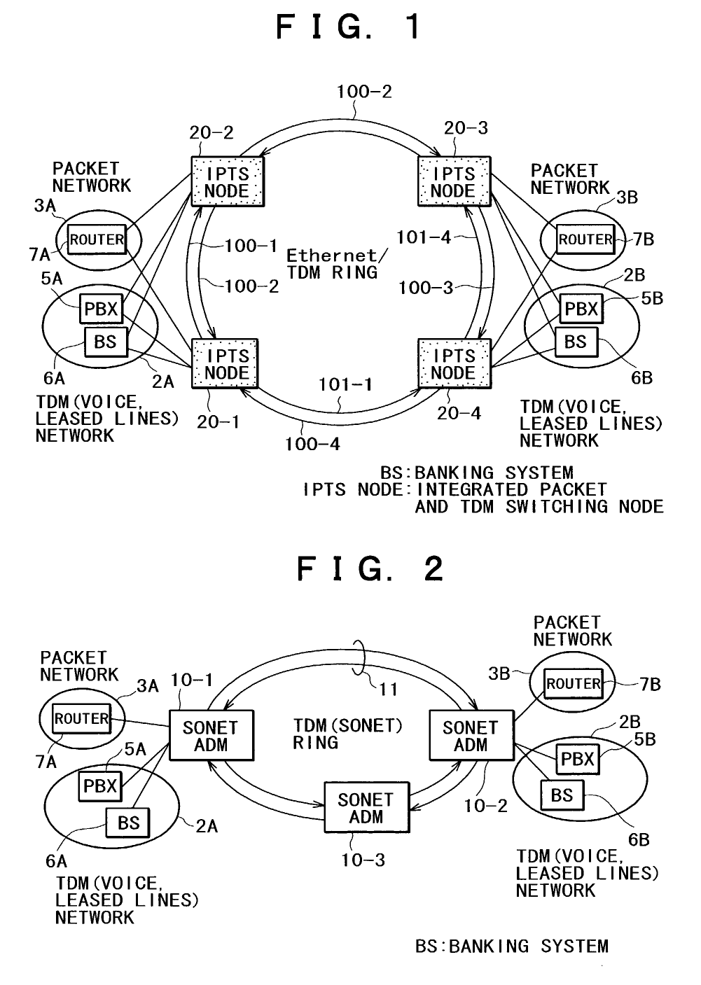

### DETAILED DESCRIPTION OF THE PREFERRED EMBODIMENT

The present invention now is described fully hereinafter with reference to the accompanying drawings, in which preferred embodiments of the invention are shown. FIG. 1 shows one network configuration example to which integrated packet and TDM switching nodes 20 (20-1 to 20-4, hereinafter abbreviated to IPTS nodes) according to the present invention are applied.

Each of the IPTS nodes 20-1 to 20-4 has high-speed line interfaces and low-speed line interfaces. The high-speed line interfaces of the IPTS nodes are connected to first optical fibers 100 (100-1 to 100-4) which form an outer ring for transmitting signals in a clockwise direction and second optical fibers 101 (101-1 to 101-4) which form an inter ring for transmitting signals in a counterclockwise direction. The low-speed line interfaces of the IPTS nodes are connected to low-speed networks such as TDM networks 2 (2A and 2B) or packet networks (3A and 3B).

In FIG. 1, the IPTS nodes 20-1 and 20-2 are connected to a PBX 5A and a banking system 6A included in the TDM network 2A and a router 7A included in the packet network 3A. The IPTS nodes 20-3 and 20-4 are connected to a PBX 5B and a banking system 6B included in the TDM network 2B and a router 7B included in the packet network 3B. In this embodiment, each IPTS node 20 supports both the RPR function which is packet-based ring network technology and the BLSR and UPSR functions which are TDM-based ring network technology.

FIG. 4 shows another network configuration example to which integrated packet and TDM switching (IPTS) nodes 20 (20-5 and 20-6) according to the present invention are applied.

In this network configuration, a first IPTS node 20-5 connected to the TDM network 2A and the packet network 3A through its low-speed line interfaces and a second IPTS node 20-6 connected to the TDM network 2B and the packet network 3B through its low-speed line interfaces are point-to-point connected by two pairs of optical fibers: one pair of fibers 100-5 and 101-6 and the other pair of fibers 100-6 and 101-5.

In this embodiment, the IPTS nodes 20-5 and 20-6 function as the apparatuses for multiplexing/demultiplexing communication channels between the packet networks 3A and 3B and communication channels transmitting and receiving traffic between the TDM networks 2A and 2B. In this network configuration, there are two pairs of paths between the IPTS nodes, one pair consisting of optical fibers 100-5 and 101-6 and another pair consisting of optical fibers 101-5 and 100-6. Thus, this embodiment has reliability against transmission path failure between the nodes and can provide support of the function of reconfiguring the networks such as RPR, BLSR, and UPSR.

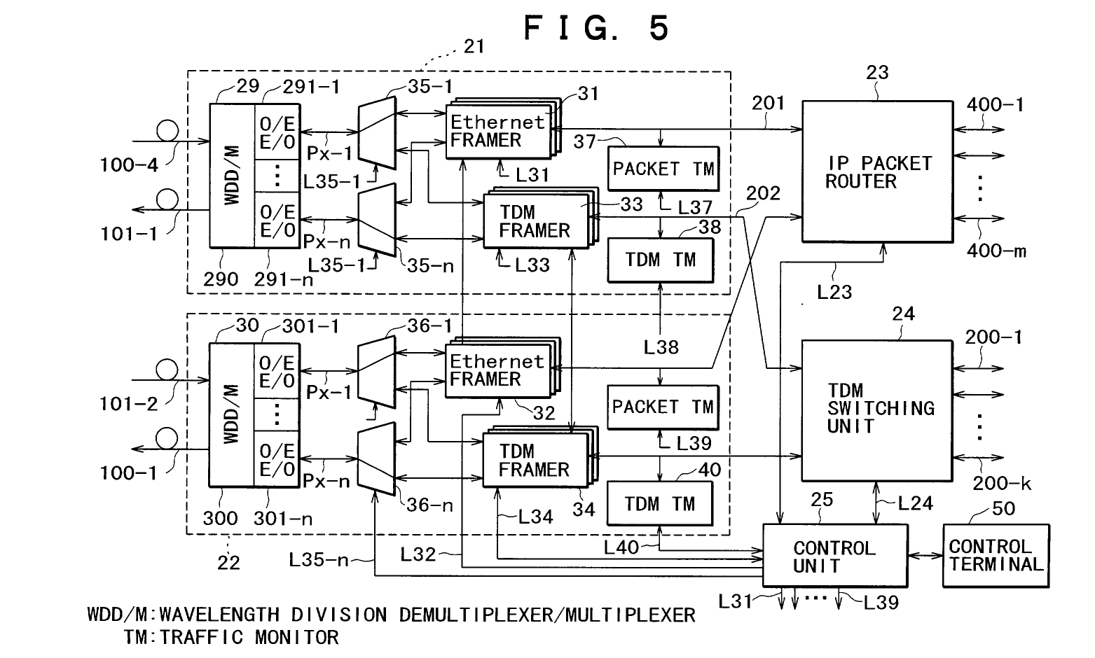

FIG. 5 shows one embodiment of an IPTS node 20 according to the present invention. The IPTS node 20 is comprised of optical line interface units 21 and 22, an IP packet router 23, a TDM switching unit 24, and a control unit 25 connected to these constituent parts. The control unit 24 is connected to a control terminal 50 that is located outside the IPTS node 20.

The optical line interface unit 21 is for communicating with an adjacent node located upstream on the outer optical ring transmission path. In the case of the IPTS node 20-1 shown in FIG. 1, its optical line interface unit 21 is comprised of optical signal circuitry 29 to which the outer optical fiber 100-4 for reception and the inner optical fiber 101-1 for transmission are connected, a plurality of Ethernet Framers 31 (31-1 to 31-n) and TDM Framers 33 (33-1 to 33-n) which are selectively connected via selectors 35 (35-1 to 35-n) to transmit/receive ports Px-1 to Px-n of the optical signal circuitry 29, a packet traffic monitor 37 for monitoring packet traffic input to and output from the Ethernet Framers 31, and a TDM traffic monitor 38 for monitoring TDM traffic input to and output from the TDM Framers 33.

The optical signal circuitry 29 is comprised of a wavelength division demultiplexer/multiplexer 290 and a plurality of optical/electrical (O/E) converters and electrical/optical (E/O) converters 291-1 to 291-n. Optical signals of different wavelengths are input to the O/E converters and output from the E/O converters. The wavelength division demultiplexer/multiplexer 290 demultiplexes wavelength-division-multiplexed optical signals of n channels received through the outer optical fiber 100-4 for reception into separate optical signals of different wavelengths (per channel) and outputs them to the per-channel O/E converters. The wavelength division demultiplexer/multiplexer 290 also wavelength division multiplexes optical signals to transmit which are of n channels output from the plurality of E/O converters and output the thus multiplexed optical signals to the inner optical fiber 101-1 for transmission.

The optical line interface unit 22 is for communicating with an adjacent node located downstream on the outer optical ring transmission path. In the case of the IPTS node 20-1 shown in FIG. 1, its optical line interface unit 22 is comprised of optical signal circuitry 30 to which the inner optical fiber 101-2 for reception and the outer optical fiber 100-1 for transmission are connected, a plurality of Ethernet Framers 32 (32-1 to 32-n) and TDM Framers 34 (34-1 to 34-n) which are selectively connected via selectors 36 (36-1 to 36-n) to transmit/receive ports Px-1 to Px-n of the optical signal circuitry 30, a packet traffic monitor 39 for monitoring packet traffic input to and output from the Ethernet Framers 32, and a TDM traffic monitor 40 for monitoring TDM traffic input to and output from the TDM Framers 34.

As is the case for the optical signal circuitry 29 of the optical line interface 21, the optical signal circuitry 30 is also comprised of a wavelength division demultiplexer/multiplexer 300 and a plurality of optical/electrical (O/E) converters and electrical/optical (E/O) converters 301-1 to 301-n.

The number of the selectors 35 (36) is determined by the number of channels n that are formed on one optical fiber by wavelength division multiplexing. To explain the IPTS node embodiment of FIG. 5, one Ethernet Framer 31 (32) and one TDM Framer 33 (34) are assumed to be connected to each of the selectors. In practical application, however, the number of the Ethernet Framers 31 (32) to be connected to the packet traffic monitor 37 (39) and the number of the TDM Framers 33 (34) to be connected to the TDM traffic monitor 38 (40) can be selected arbitrarily within the range of n, the number of channels.

For example, if n=8, it is possible to use channels 1 to 4 for TDM only and channels 5 to 8 as common TDM/packet channels. The node may be configured to have four Ethernet Framers 31 (32) and eight TDM Framers 33 (34); in this case, the TDM transmission load on the node is weighted. Inversely, it is possible to use channels 1 to 4 for packet only and channels 5 to 8 as common TDM/packet channels. The node may be configured to have eight Ethernet Framers 31 (32) and four TDM Framers 33 (34); in this case, the packet transmission load on the node is weighted. In these cases, the hardware may be arranged such that the Ethernet or TDM Framers for the channels for packet only or TDM only are directly connected to the transmit/receive ports without the intervention of the selectors.

By mode (transmission mode) switchover between TDM and packet of the selectors 35 (36), a plurality of channels formed on an optical ring transmission path by wavelength division multiplexing can be assigned to TDM transmission and packet transmission at any TDM-to-packet ratio.

As concerns the packet traffic monitor 37 (39) and the TDM traffic monitor 38 (40), separate monitors per channel may be provided, or a single one may be used for monitoring packet or TDM traffic on the plurality of channels.

An Ethernet Framer 31 (32) executes termination of a received frame compliant with a protocol of layer 2 of an Open Systems Interconnection (OSI) reference model (for example, an Ethernet frame pursuant to the RPR specifications), received through an optical ring transmission path (the optical fiber 100-4 or 101-2) The Ethernet Framer 31 (32) determines whether the MAC address specified in the received frame matches the MAC address of the IPTS node that received the frame. If MAC address matching occurs, the Ethernet Framer 31 (32) extracts a higher layer packet (IP packet) from the received frame and transfers it to the IP packet router 23 (Drop action). If a MAC address mismatch is found, the Ethernet Framer 31 (32) transfers the received frame to the corresponding Ethernet Framer 32 (31) in the other optical line interface 22 (21) (Through action).

From the IP packet router 23, when the Ethernet Framer 31 (32) receives an IP packet to transmit, it generates an Ethernet frame header by referring to an address translation table containing predefined mapping between destination IP addresses and destination MAC addresses, converts the IP packet to transmit into an Ethernet frame to transmit, and transfers the Ethernet frame to the optical signal circuitry 29 via the selector 35-1 (Add action). The Ethernet Framer 31 (32) receives an Ethernet frame from the other Ethernet Framer 32 (31) that serves the same channel and sends it to the optical signal circuitry 29 via the selector 35-1 (Through action).

The IP packet router 23 switches an IP packet input from one of the Ethernet Framers 31, 32 to one of the low-speed I/O lines 400-1 to 400-m which are connected to the packet network 3A or 3B shown in FIG. 1 or an IP packet input from one of the lower-speed I/O lines to one of the Ethernet Framers 31, 32, according to the destination address specified in the header of the IP packet.

On the other hand, a TDM Framer 33 (34) executes termination of a SONET frame received through an optical ring transmission path (the optical fiber 100-4 or 101-2). The TDM Framer 33 (34) transfers such TDM data extracted from the time slots of the SONET frame that is to be forwarded to the adjacent node to the corresponding TDM Framer 34 (33) in the other optical line interface 22 (21). The TDM Framer 33 (34) transfers the TDM data to be forwarded to the TDM network to which the IPTS node that received the SONET frame is connected to the TDM switching unit 24. The TDM Framer 33 (34) sets TDM data received from the TDM switching unit 24 and a TDM frame received from the other TDM Framer 34 (33) in predetermine time slots of a SONET frame and sends the SONET frame to the optical signal circuitry 29 (30) via the selector 35-n.

The TDM switching unit 24 executes line switching of TDM data input from one of the TDM Framers 33, 34 to one of the low-speed I/O lines 200-1 to 200-k which are connected to the TDM network 2A or 2B shown in FIG. 1 or TDM data input from one of the low-speed I/O lines to one of the TDM Framers.

Traffic carried over the channels is monitored by the packet traffic monitors 37, 39 and the TDM traffic monitors 38, 40 and the control unit 25 collects the traffic data through signal lines L37, L38, L39, and L40. The control unit 25 periodically collects the traffic data for the channels and outputs traffic transition per channel to the control terminal 50 by request of the operator at the control terminal 50.

The control unit 25 controls the selectors 35-i, 36-i, (i=1 to n) in the optical line interface units by request of the operator at the control terminal 50 or automatically from the result of analysis of traffic data collected from the monitors. The control unit 25 switches a channel from packet transmission mode to TDM transmission mode or from TDM transmission mode to packet transmission mode if necessary. Mode switchover of the selectors 35-i and 36-i is performed by a mode switching signal output from the control unit 25 to control signal lines L35-i so that the same channel is set in the same transmission mode.

The control unit 25 is connected to the Ethernet Framers 31 (31-1 to 31-n), 32 (32-1 to 32-n) and TDM Framers 33 (33-1 to 33-n), 34 (34-1 to 34-n) by control signal lines L31 (131-1 to L31-n), L32 (L32-1 to L32-n), L33 (L33-1 to L33-n), and L34 (L34-1 to L34-n). The control unit 25 is also connected to the IP packet router 23 and TDM switching unit 24 by control signal lines L12 and L24. Through these control signal lines, the control unit 25 supplies control commands to these components and updates the routing tables and other parameter tables that these components retain.

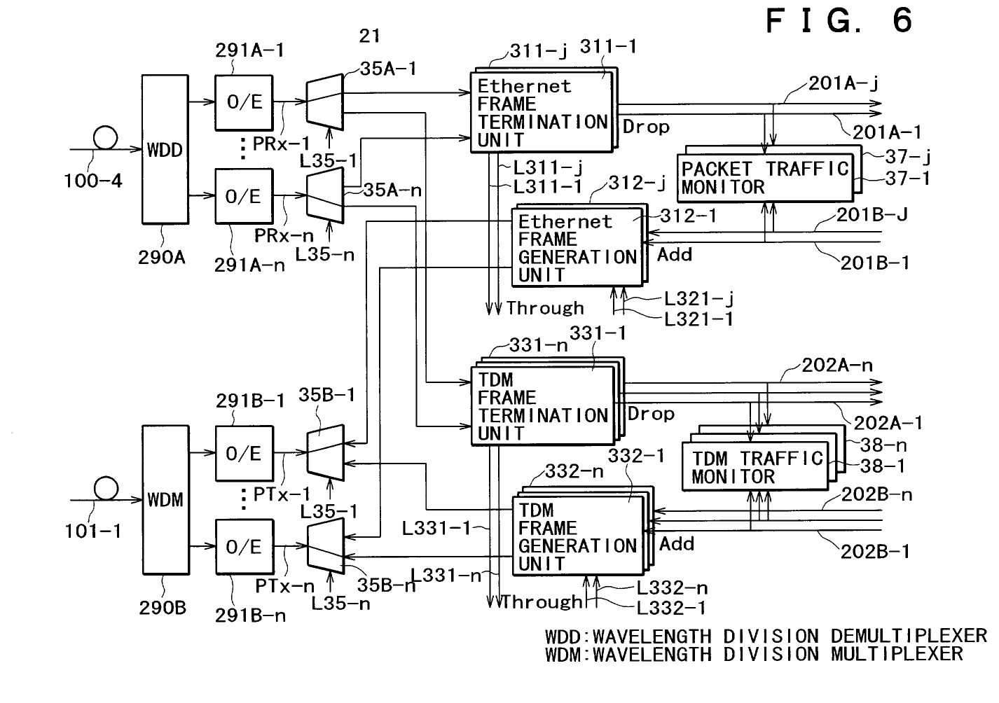

FIG. 6 is a block diagram showing detailed structure of the optical line interface unit 21. The optical line interface unit 22 also has the same structure as shown in FIG. 6.

Wavelength-division-multiplexed optical signals of n channels received through the optical fiber 100-4 are demultiplexed into separate optical signals of different wavelengths by the wavelength division demultiplexer/multiplexer 290A. The separate optical signals are input to the per-wavelength (per-channel) optical/electrical (O/E) converters 291A-1 to 291A-n and converted to electrical received frame signals. The received frame signals are input via the receive ports PRx-1 to PRx-n to the selectors 35A-1 to 35A-n.

To each of the selectors 35A-i, (i=1 to n), at least one of the Ethernet frame termination units and TDM frame termination units. In this embodiment, assume that the TDM frame termination units are respectively connected to all selectors 35A-i (i=1 to n) and the Ethernet frame termination units are respectively connected to selectors 1 to j (j<n); therefore, (j+1)-th to n-th selectors are for TDM only.

Among the Ethernet frame termination units and TDM frame termination units arranged in the optical line interface unit 21, those selected by the associated selectors 35-i (i=1 to n) are enabled logically and physically and executes termination of the received frame on each channel.

The Ethernet frame termination units 311-a to 311-j are enabled when their associated selectors are set in packet transmission mode and execute termination of an Ethernet frame (or RPR frame) input from one of the receive ports PRx-i (i=1 to j). Among Ethernet frames received, for an Ethernet frame to drop to a packet network (Drop) the Ethernet frame termination unit that received it extracts an IP packet from the frame and transfers the IP packet to the IP packet router 23 via one of the signal lines 201A-1 to 201A-j. For an Ethernet frame to be forwarded to the Next node (Through), the Ethernet frame termination unit that received it transfers it via one of the signal lines L311-1 to L311-j to the Ethernet frame generation unit for the corresponding channel in the other optical line interface 22.

The TDM frame termination units 331-1 to 331-j are enabled when their associated selectors are set in TDM transmission mode, execute termination of a SONET frame input from one of the receive ports PRx-i (i=1 to j), and extract TDM data from the time slots of the frame. Among TDM data received, for TDM data to drop to a TDM network (Drop), the TDM frame termination unit that received it transfers it via one of the signal lines 202A-1 to 202A-n to the TDM switching unit 24. For TDM data to be forwarded to the next node (Through), the TDM frame termination unit that received it transfers it via one of the signal lines L331-1 to L331-i to the TDM frame generation unit for the corresponding channel in the other optical line interface 22.

In the optical line interface unit 21, Ethernet frame generation units 312 to 312-j as many as the Ethernet frame termination units 311-1 to 311-j and TDM frame generation units 332-1 to 332-i as many as the TDM frame termination units 331-1 to 331-i are arranged.

Among the Ethernet frame generation units 312-1 to 312-j, those selected by the associated selectors 35B-1 to 35B-j are connected to the electrical/optical converters 291B-1 to 291B-j via the transmit ports PTx-1 to PTx-n. The TDM frame generation units 332-1 to 332-i selected by the associated selectors 35B-1 to 35B-i are also connected to the electrical/optical converters 291B-1 to 291B-i via the transmit ports PTx-1 to PTx-n. Optical frame signals to transmit of n channels with different wavelengths output from the electrical/optical converters 291B-1 to 291B-i are multiplexed by the wavelength division multiplexer 290B and output to the optical fiber 101-1.

Switchover control is exerted to concurrently switch the corresponding ones of the selectors 35B-1 to 35B-n and the selectors 35A-1 to 35A-n so that a pair of an Ethernet frame generation unit 312-i and an Ethernet frame termination unit 311-i (i=1 to j) or a pair of a TDM frame generation unit 332-i and a TDM frame termination unit 331-i (i=1 to n) will be connected to the same channel on the optical ring transmission path.

For example, when the k-th Ethernet frame termination unit 311-k is connected to the receive port PRx-k by the selector 35A-k, the selector 35B-k connects the k-th Ethernet frame generation unit 312-k to the transmit port PTx-k. Similarly, when the k-th TDM frame termination unit 331-k is connected to the receive port PRx-k by the selector 35A-k, the selector 35B-k connects the k-th TDM frame generation unit 332-k to the transmit port PTx-k. Moreover, when transmission mode switchover of the selector 35A-k and 35B-k occurs in the optical line interface 21, transmission mode switchover of the selector 35A-k and 36B-k occurs simultaneously in the optical line interface 22.

When the selector 35B-k is set in packet transmission mode, the Ethernet frame generation unit 312-k receives an IP packet from the IP packet router 23 through the signal line 201B-k and adds an Ethernet header to the IP packet, thus converting the IP packet into an Ethernet frame. The Ethernet frame generation unit 312-k writes a destination MAC address mapped to the destination IP address of the IP packet in the Ethernet header and outputs the Ethernet frame to the transmit port PTx-k. When the selector 35B-k is set in TDM transmission mode, the TDM frame generation unit 332-k receives TDM data from the TDM switching unit 24 through the signal line 202B-k, sets the TDM data in predetermined time slots of a SONET frame, and outputs the SONET frame to the transmit port PTx-k.

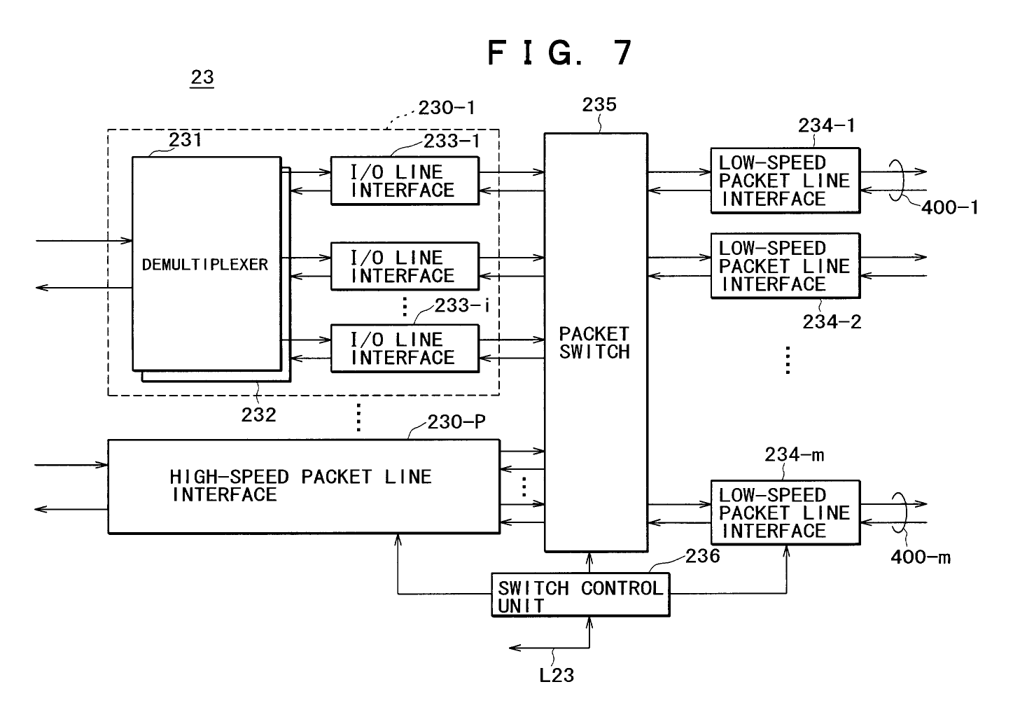

FIG. 7 shows one embodiment of the IP packet router 23.

The IP packet router 23 is comprised of a plurality of high-speed packet line interfaces 230-1 to 230-p which are connected to the Ethernet Framers 31 (Ethernet frame termination units 311-1 to 311-j and Ethernet frame generation units 312-1 to 312-j) arranged in the optical line interface unit 21 or the Ethernet Framers 32 arranged in the optical line interface unit 22, a plurality of low-speed packet line interfaces 234-1 to 234-m which accommodate the I/O lines from/to the packet network 3A or 3B, a packet switch 235 for switching IP packets from the high-speed packet line interfaces to the low-speed packet line interfaces and vice versa, and a switch control unit 236 connected to the above line interfaces and the packet switch.

In this embodiment, arrangement is made so that high-speed packets input and output to/from the optical line interface units 21 and 22 will be input and output to/from the packet switch 235 at a rate as low as the rate at which packets are input and output to/from the low-speed packet line interfaces 234-1 to 234-m. For this purpose, each high-speed packet line interface 230 is comprised of a plurality of Processing Units 233-1 to 233-i, a demultiplexer 231 for distributing IP packets received from the Ethernet frame termination units 311 to the plurality of Processing Units, and a multiplexer 232 for multiplexing IP packets to transmit, output from the plurality of Processing Units, and supplying the thus multiplexed packets to the Ethernet frame generation units 312.

Each Processing Unit 233 has a routing table containing predefined mapping between destination IP addresses and output port numbers of the packet switch 235. When the Processing Unit receives an IP packet from the demultiplexer, it reads the output port number mapped to the destination address of the received packet from the routing table, adds an internal header having the output port number written in it to the packet, and stores the packet into the output buffer. Each low-speed packet line interface 234 also has the same routing table as the Processing Unit 233 has. When the low-speed packet line interface receives an IP packet from the packet network, it writes the output port number mapped to the destination address of the received packet into an internal header, adds the internal header to the packet, and stores the packet into the output buffer.

The packet switch 235 sequentially reads IP packets from the output buffers of the low-speed line interfaces 234 and Processing Units 233 and switches an IP packet to any line interface, according to the output port number specified in the internal header of the packet. When a low-speed packet line interface 234 receives an IP packet from the packet switch 235, it removes the internal header that is no longer needed, and transfers the IP packet to the packet network.

When an Processing Unit 233 receives an IP packet from the packet switch 235, it removes the internal header that is no longer needed, and transfers the IP packet to the multiplexer 232. The routing table retained on each line interface is updated by the switch control unit 236. The switch control unit 236 is connected to the control unit 25 shown in FIG. 5.

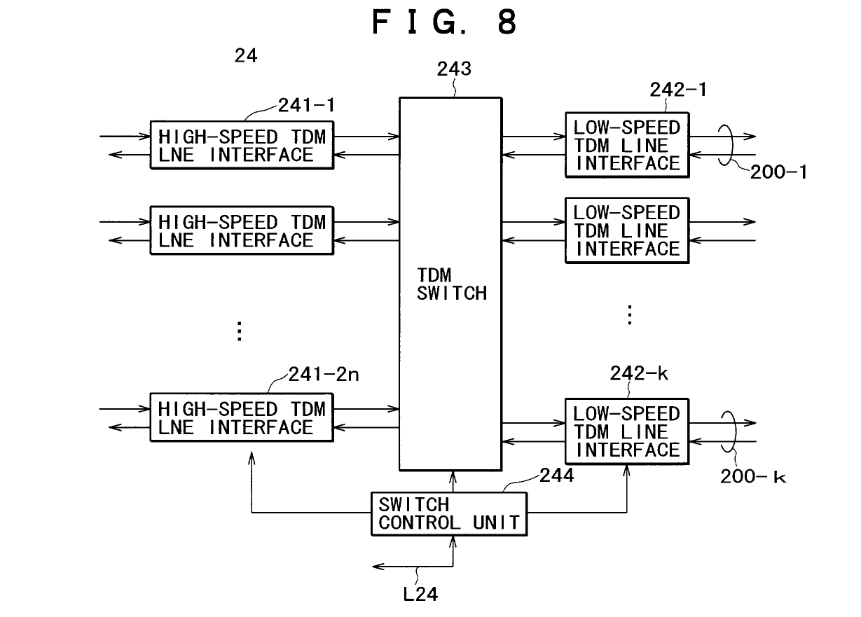

FIG. 8 shows one embodiment of the TDM switching unit 24.

The TDM switching unit is comprised of a plurality of high-speed TDM line interfaces 241-1 to 241-2n, each of which accommodates I/O lines from/to each of the TDM Framers 33 (TDM frame termination units 331-1 to 331-n and TDM frame generation units 332-1 to 332-n) arranged in the optical line interface unit 21 and the TDM Framers 34 arranged in the optical line interface unit 22, a plurality of low-speed TDM line interfaces 242-1 to 242-k which accommodate the I/O lines from/to the TDM network 2A or 2B, a TDM switch 243 for switching TDM data from the high-speed TDM line interfaces to the low-speed TDM line interfaces and vice versa, and a switch control unit 244 connected to the line interfaces and the TDM switch.

As described above, the IPTS node 20 according to the present invention realizes both packet transmission and TDM transmission on a same optical ring transmission path in the following manner. For a plurality of channels wavelength-division-multiplexed on an optical ring transmission path, the per-channel selectors 35 (35-1 to 35-n) and 36 (36-1 to 36n) selectively connects the transmit/receive ports Px-1 to Px-n (PRx-1 to PRx-n and PTx-1 to PTx-n) for the channels to the Ethernet Framers 31 (311-1 to 312-j) and 32 or the TDM Framers 33 (331-1 to 332-n) and 34.

The selectors 35 and 36 can be switched at any time between two modes, packet transmission and TDM transmission, by a mode switching signal that is output from the control unit 25 and carried through one of the signal lines L35 (L35-1 to L35-n).

In the IPTS node 20 of the present invention, traffic on the channels is monitored by the packet traffic monitors 37 and 39 and TDM traffic monitors 38 and 40. The control unit 25 collects traffic data by, for example, periodically polling the monitors, and outputs current transmission mode and traffic transition for each channel to the control terminal 50 when the operator at the control panel 50 requests traffic data output.

From the transmission mode and traffic transition for each channel displayed on the terminal screen, the operator at the control terminal 50 determines whether to take a transmission mode switchover. In consequence, given that, for example, the selectors 35-1 and 36-1 for the first channel shown in FIG. 5 should be switched from packet transmission mode to TDM mode to shift the packet transmission load on the first channel to the second channel that is still in packet transmission mode, the operator must carry out the following procedure to make a transmission mode changeover of the first channel.

First, the operator must enter a first command to change the packet transfer route from the first transmit/receive port Px-1 to the second transmit/receive port Px-2, and the first command is supplied from the control terminal 50 to the control unit 25. Upon the reception of the first command, the control unit 25 notifies the Ethernet Framers 31-1 and 32-1 that are being connected to the first transmit/receive port Px-1 of closing of the transmit/receive port through the control signal lines L31-1 and L32-1. The control unit 25 notifies the switch control unit 236 in the IP packet router 23 of route change from the first transmit/receive port Px-1 to the second transmit/receive port Px-2. Then, the control unit 25 returns a response to the first command to the control terminal 50.

When the control terminal 50 receives the response, the operator must enter a second command to switch the first transmit/receive port Px-1 to TDM transmission mode. Upon the reception of the second command from the control terminal 50, the control unit 25 sends a mode switching signal through the control signal line L35-1 to the first transmit/receive port Px-1 and returns a response to the second command to the control terminal 50. Because the control signal line L35-1 is common for the optical line interfaces 21 and 22, the selectors 35-1 (35A-1 and 35B-1 in FIG. 6) and 36-1 switch to TDM transmission mode by receiving the mode switching signal, and consequently, the TDM Framers 33-1 and 34-1 are connected to the transmit/receive port Px-1.

When the control terminal 50 receives the response to the second command from the control unit 25, the operator must enter a third command to open the first transmit/receive port Px-1. Upon the reception of the third command from the control terminal 50, the control unit 25 notifies the TDM Framers 33-1 and 34-1 which are connected to the first transmit/receive port Px-1 of opening of that transmit/receive port through the control signal lines L33-1 and L34-1. The control unit 25 notifies the switch control unit 244 in the TDM switching unit 24 of opening of the first transmit/receive port Px-1 through the control signal line L24 and returns a response to the third command to the control terminal 50.

When the switch control unit 236 in the IP packet router 23 receives the notification of route change from the first transmit/receive port Px-1 to the second transmit/receive port Px-2 from the control unit 25, it makes packet transfer route change in the packet switch 235 so that packets so far output to the high-speed packet line interface 230-1 that is connected to the first Ethernet Framer 31-1 in the optical line interface unit 21 will be transferred to the high-speed packet line interface 230-2 that is connected to the second Ethernet Framer 31-2 and packets so far output to the high-speed packet line interface 230-(j+1) that is connected to the first Ethernet Framer 32-1 in the optical line interface unit 22 will be transferred to the high-speed packet line interface 230-(j+2) that is connected to the second Ethernet Framer 32-2.

The above route change updates the routing tables retained on the low-speed packet line interfaces 234-1 to 234-m; that is, the output port numbers assigned to the high-speed packet line interfaces 230-1 and 230-(j+1) are replaced by the output port numbers assigned to the high-speed packet line interfaces 230-1 and 230-(j+2).

When the Ethernet Framers 31-i and 32-i and TDM Framers 33-i and 34-i (i=1 to n) receive the notification of opening of the transmit/receive port Px-1 from the control unit 25, they start transmission and reception of frames to/from the optical signal circuitry 29 or 30. When these frame manipulating units receive the notification of closing the transmit/receive port Px-1 from the control unit 25, they stop transmission and reception of frames to/from the optical signal circuitry.

When the switch control unit 244 in the TDM switching unit 24 receives the notification of opening of the transmit/receive port Px-1 from the control unit 25, it enables the high-speed TDM line interfaces 241-1 and 241-(n+1) for the first channel in the control table of the TDM switch 243 and allocates incoming TDM connections to these high-speed TDM line interfaces 241-1 and 241-(n+1).

While the operator enters the first, second, and third commands sequentially in the above-described procedure, it is also preferable that the operator supplies these commands all together to the control unit 25. Then, the control unit 25 sequentially executes the first, second, and third commands and returns a response to the control terminal 50 upon the completion of all commands. In stead of the first, second, and third commands, a control message in which the operator must specify parameters for switch-to-mode of transmission, port number to which the route changes, etc. may be supplied to the control unit 25 which, in turn, analyzes the control message and generates the first, second, and third commands.

Channel transmission mode switchover described above must be performed synchronously on all nodes constituting the ring network, not freely on an individual node.

In the case of the network shown FIG. 1, to the control units 25 of the IPTS nodes 20-1 to 20-4, their control terminals 50 are connected. At each control terminal 50, the operator observes the transmission mode and traffic transition per channel on the node and determines whether to take a transmission mode switchover. If observed traffic transition situation demands the transmission mode changeover of a channel as described above, in practical application, the following must be done. For example, the operators of the IPTS nodes contact with each other, determine day and time when transmission mode switchover is to be performed and what channel for which switchover is to be done, and start the operation for transmission mode switchover at the same time on all IPTS nodes.

Instead of sharing information such as day and time when transmission mode switchover is to be performed among the operators of the IPTS nodes by contacting with each other, for example, the following is also preferable. From the control terminal 50 connected to one IPTS node, enter a control message in which the operator must specify control parameters for time when transmission mode switchover is to be performed, what channel for which switchover is to be done, switch-to-mode of transmission, a port to which the route changes, etc. This control message is sent to the control units 25 of all IPTS nodes through the standby path of the dual rings so that all control units 25 will execute transmission mode switchover control together at the specified time.

In the ring network configuration shown in FIG. 1, if, for example, the first optical fiber 100 is an active path and the second optical path 101 is a standby path, the standby optical fiber 101 is used for transmission of control packets. The control message entered from the control terminal 50 connected to one IPTS node is converted into a control packet on the control unit 25 that received it. The control unit 25 inputs the control packet to the IP packet router 23 through the control signal line L23 and the control packet is transferred to the appropriate Ethernet Framer 31 and output to the optical fiber 101.

By thus transmitting the control packet one by one to other IPTS nodes, the control units 25 of all IPTS nodes constituting the ring network obtain control parameters for time when transmission mode switchover is to be performed and others required for switchover, so that switchover of transmission mode of the specified channel and internal transfer route change can be performed at the same time by the control units 25 on all nodes. It is also preferable to use the broadcast addresses of the destinations so that all other IPTS nodes can receive one control packet.

While transmission mode switchover is performed by the commands from the operator in the above-described embodiment, the IPTS node of the present invention can also be embodied such that the control units automatically performs transmission mode switchover, according to traffic change per channel, and dynamically changes the channel assignments for TDM transmission and packet transmission.

In another embodiment, the switch control unit 236 in the IP packet router monitors packet traffic per channel and the switch control unit 244 in the TDM switching unit 24 monitors TDM traffic per channel, and the control unit 25 collects traffic data from these switch control units through the signal lines L23 and L24.

Automatic transmission mode switchover by the control unit 25 can be implemented as follows. For example, for TDM traffic and packet traffic, set a first threshold by which a new channel is assigned and a second threshold by which a channel is released. If TDM traffic (packet traffic) exceeds the first threshold and packet traffic (TDM traffic) is lower than the second threshold, among the channels in packet (TDM) transmission mode, one channel that carries the least traffic is switched to TDM (packet) transmission mode. The transfer router of packets (TDM) so far transmitted over that channel is switched to another channel in packet (TDM) transmission mode.

The control unit 25 analyzes traffic per channel and determines what channel for which transmission mode switchover is to be done and what port to which the router changes. Thereafter, the same procedure as for transmission mode switchover by operator command described above is applied and automatic transmission mode changeover by the control unit 25 can be performed. Also in this case, notification of when transmission mode switchover is to be performed and other control parameters is sent from the control unit 25 that determined route change to other IPTS nodes on the ring network, using the standby path, so that transmission mode changeover can be performed at the same time on all IPTS nodes. Time when switchover is to be performed may be set for time after the elapse of a predetermined time from the time when route change is determined. It is also possible that the IPTS nodes autonomously determine a port to which the route changes when automatic transmission mode switchover is performed.

On the IPTS node of the present invention, the transmit/receive ports Px-1 to Px-n in the optical line interfaces 21 and 22 transmit and receive signals of frames that are physically multiplexed on a same optical transmission path. However, logically, these ports function as completely dependent TDM or packet transmission ports, and it is impossible that the same port serves both packet and TDM transmission at the same time.

According to the present invention, when all the selectors 35-i and 36-i (i=1 to n) shown in FIG. 5 are set in TDM transmission mode, the IPTS node 20 can function as a TDM node. In this case, the Ethernet Framers 31 and 32 take all transmit/receive ports Px to connect to as being closed. However, higher-layer software need not care about whether the transmit/receive ports PX operate in TDM transmission mode.

Inversely, when the Ethernet Framers are arranged for all channels and all the selectors 35-i and 36-i (i=1 to n) are set in packet transmission mode, the IPTS node 20 can function as an Ethernet node. In this case, the TDM Framers 33 and 34 take all transmit/receive ports Px to connect to as being closed. However, higher-layer software need not care about whether the transmit/receive ports PX operate in TDM transmission mode.

When a part of the selectors 35-i and 36-i (i=1 to n) are set in TDM transmission mode and the remaining ones are set in packet transmission mode, the IPTS node 20 functions as a node serving for both TDM and Ethernet. In this case, deselected Ethernet Framers and TDM Framers simply take the transmit/receive ports Px to connect to being closed, as is the case for the above-described TDM node and Ethernet node. Therefore, TDM transmission and packet transmission by the IPTS node 20 of the present invention do not require special software and processing peculiar to the invention and ordinary applications can be applied to the operation of the IPTS node.

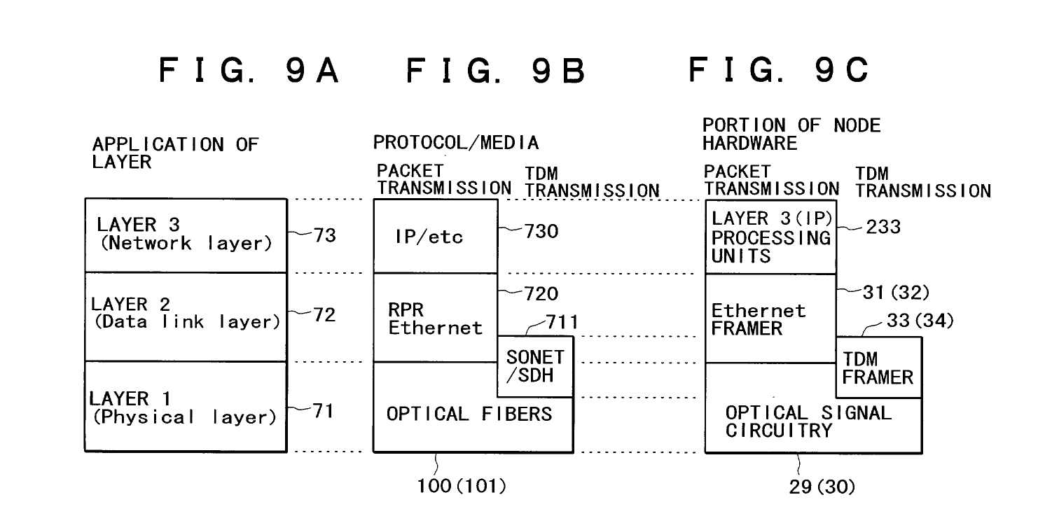

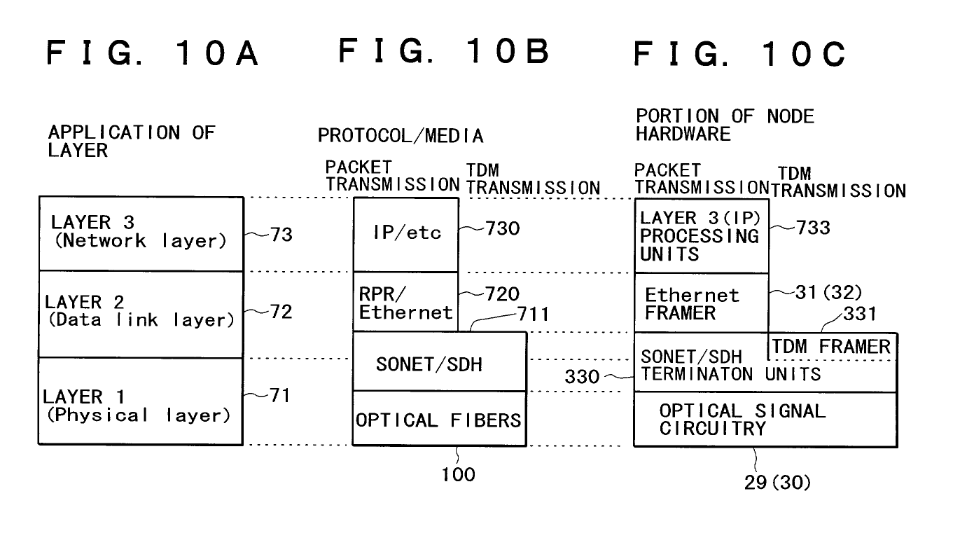

FIGS. 9A to 9C show a stack of protocols for running an IPTS node 20.

The node operation phases are hierarchically represented in terms of (FIG. 9A) application of layer of the OSI reference model, (FIG. 9B) protocol/media, and (FIG. 9C) a responsible portion of hardware of the IPTS node.

Layer 1 (physical layer) 71, layer 2 (data link layer) 72, and layer 3 (network layer) 73 of the OSI reference model are respectively associated with optical fibers 100 (101), SONET/SDH 711, RPR/Ethernet 720, and IP/etc. 730 as shown.

When packet transmission is performed, the Ethernet Framers 31 (32) manipulate variable-length packet frames of RPR or Ethernet and the Processing Units 233 in the IP packet router 23 route IP packets of layer 3. When TDM transmission is performed, the TDM Framers 33 (34) execute termination of SONET/SDH frames and manipulate fixed-length TDM frames. The RPR/Ethernet variable-length packet frames and fixed-length TDM frames are E/O converted into optical signals with different wavelengths and wavelength division multiplexed in the optical signal circuitry 29 (30) and output to the same optical fiber.

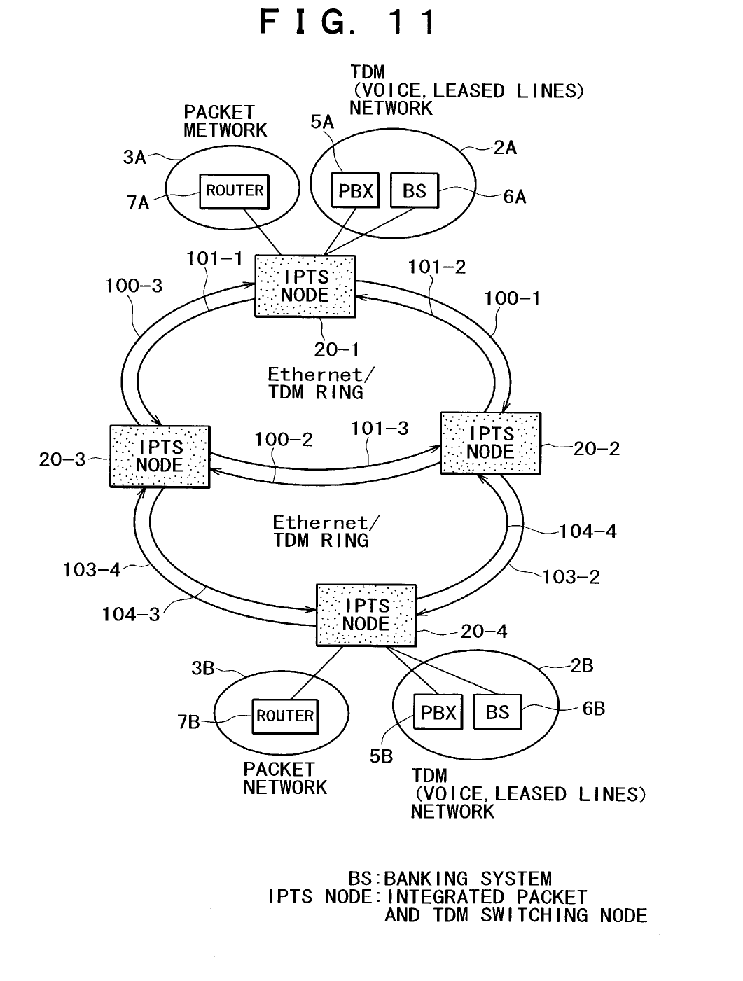

FIGS. 10A to 10C show another example of a stack of protocols applicable to the IPTS node 20 of the present invention.

In this example, as seen from (FIG. 10B) protocol/media, SONET/SDH 711 is a common protocol for packet transmission and TDM transmission. SONET/SDH frames containing RPR/Ethernet variable-length packet frames and SONET/SDH frames containing fixed-length TDM frames, which are different wavelengths, are wavelength division multiplexed on the same optical fiber.

In this case of embodiment, the IPTS node is configured such that SONET/SDH termination units 330 that are common for packet transmission and TDM transmission are installed between the O/E converters 291 (301) and the selectors 35 (36) shown in FIG. 5. After termination of received SONET/SDH frames, the frames are input to the Ethernet Framers 31 (32) or TDM Framers 33 (34). In this case, the TDM Framers 33 (34) need not have an SONET/SDH frame termination function, and must have only the function of manipulating fixed-length TDM frames.

FIG. 11 shows yet another network configuration example to which to which integrated packet and TDM switching (IPTS) nodes 20 (20-1 and 20-4) according to the present invention are applied.

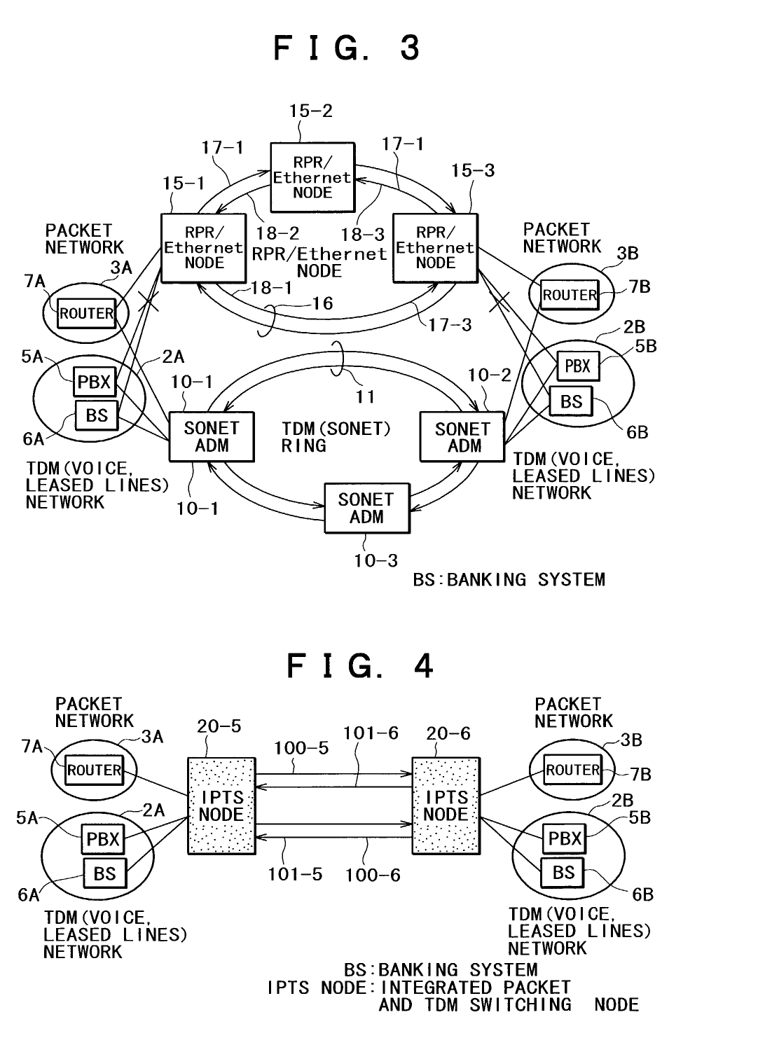

In the network architecture of FIG. 11, the IPTS nodes 20 are installed instead of SONET ADMs 10 and RPR/Ethernet nodes 15 shown in FIG. 3 and already laid optical fibers are used.

The IPTS nodes 20-1 to 20-3 are connected by two ring transmission paths, one consisting of optical fibers 100-1 to 100-3 and the other consisting of optical fibers 101-1 to 101-3. The IPTS node 20-4 is connected to the IPTS nodes 20-2 and 20-3 by two ring transmission paths: one consisting of optical fibers 103-3 and 103-4 and the other consisting of optical fibers 104-3 and 104-4. The existing optical fibers can be used as part of these ring transmission paths.

The IPTS node 20-1 is connected to a TDM network 2A and a packet network 3A through its low-speed line interfaces. The IPTS node 20-4 is connected to a TDM network 2B and a packet network 3B through its low-speed line interfaces. Packet traffic and TDM traffic served by the IPTS node 20-1 are transmitted to the packet network or TDM network to which the IPTS network 20-4 connects via a plurality of ring networks.

The IPTS nodes 20-2 and 20-3 at the junctions of two ring networks, which are different from the IPTS nodes 20-1 and 20-4, have three optical line interfaces. For the IPTS nodes 20-2 and 20-3, a third optical line interface is added to the node configuration shown in FIG. 5 and received packets and TDM data are passed (Through action) across three optical line interfaces. The IPTS nodes 20-1 and 20-4 can also accommodate a TDM network and a packet network and support RPR, BLSR/UPSR, and other functions.

Application of the above-described IPTS node of the present invention makes it possible to integrate a packet-based network and a TDM-based network into one network and consolidate network management.

In the event that a TDM node becomes failed in an existing TDM network and must be replaced by a new node, continuation of the TDM-based network operation is possible by applying the IPTS node with all channels being set in TDM transmission mode. Thus, the IPTS node of the present invention can replace a node in the existing TDM network.

If the IPTS node of the present invention is used in a TDM-based network, when TDM-based traffic decreases while packet-based traffic increases, a TDM transmission channel of decreased load can be switched to a packet transmission channel. In this way, the network can be tailored to a packet-based network, using the existing optical transmission paths.

As clarified from the described embodiments, a network formed by the IPTS nodes of the present invention can serve for both packet-based communication and TDM-based communication (over voice and leased lines). Thus, network management will be easier and a high-speed packet network can be built by making effective use of the existing transmission paths.

What is claimed is:

1. An integrated packet and TDM switching node apparatus which receives wavelength-division-multiplexed optical signals of a plurality of channels incoming through a first optical transmission path and transmits wavelength-division-multiplexed optical signals of a plurality of channels over a second optical transmission path, the integrated packet and TDM switching node apparatus comprising:
at least one TDM Framer;
at least one packet Framer; and
means for allocating optical signals of different wavelengths to said TDM Framer and packet Framer,
wherein the integrated packet and TDM switching node apparatus wavelength division multiplexes TDM frame transmission channels and packet frame transmission channels on said first and second optical transmission paths.

2. An integrated packet and TDM switching node apparatus comprising:
optical signal circuitry which receives wavelength-division-multiplexed optical signals of a plurality of channels incoming through a first optical transmission path, converts the optical signals into electrical signals, and outputs the electrical signals to a plurality of per-channel receive ports, while converting electrical signals received from a plurality of per-channel transmit ports into wavelength-division-multiplexed optical signals of a plurality of channels and transmitting these wavelength-division-multiplexed optical signals over a second optical transmission path;
at least one TDM Framer;
at least one packet Framer; and
means for connecting said TDM Framer and packet Framer to separate transmit/receive ports of said optical signal circuitry for different channels.

3. An integrated packet and TDM switching node apparatus as claimed in claim 2, further comprising selectors for selectively connecting at least one pair of transmit/receive ports of said optical signal circuitry to said TDM Framer or packet Framer.

4. An integrated packet and TDM switching node apparatus comprising:
optical signal circuitry which receives wavelength-division-multiplexed optical signals of a plurality of channels incoming through a first optical transmission path, converts the optical signals into electrical signals, and outputs the electrical signals to a plurality of per-channel receive ports, while converting electrical signals received from a plurality of per-channel transmit ports into wavelength-division-multiplexed optical signals of a plurality of channels and transmitting these wavelength-division-multiplexed optical signals over a second optical transmission path;
a plurality of TDM Framers;
a TDM switching unit for switching TDM data from said plurality of TDM Framers to a TDM network and vice versa;
a plurality of packet Framers;
a packet router for switching packets from said plurality of packet Framers to a packet network and vice versa; and
means for connecting said plurality of TDM Framers and packet Framers to separate transmit/receive ports of said optical signal circuitry for different channels.

5. An integrated packet and TDM switching node apparatus as claimed in claim 4, further comprising selectors for selectively connecting each of a plurality of pairs of transmit/receive ports of said optical signal circuitry to one of said TDM Framers or one of said packet Framers.

6. An integrated packet and TDM switching node apparatus as claimed in claim 5, further comprising a control unit which controls said selectors for changing the connections between said transmit/receive ports and said TDM Framers as well as said packet Framers.

7. An integrated packet and TDM switching node apparatus which is connected to a network formed by first and second optical rings, wherein the direction of signal transmission over the first optical ring is opposite to the direction of signal transmission over the second optical ring, the integrated packet and TDM switching node apparatus comprising:
a first optical line interface unit which is connected to a first adjacent node apparatus via said network formed by the first and second optical rings;
a second optical line interface unit which is connected to a second adjacent node apparatus via said network formed by the first and second optical rings;
a TDM switching unit for switching TDM data from said first and second optical line interface units to a TDM network and vice versa; and
a packet router for switching packets from said first and second optical line interface units to a packet network and vice versa,
each of said first and second line interface units comprising:
optical signal circuitry which receives wavelength-division-multiplexed optical signals of a plurality of channels transmitted from said first or second adjacent node apparatus, converts the optical signals into electrical signals, and outputs the electrical signals to a plurality of per-channel receive ports, while converting electrical signals received from a plurality of per-channel transmit ports into wavelength-division-multiplexed optical signals of a plurality of channels and transmitting these wavelength-division-multiplexed optical signals to said first or second adjacent node apparatus;
a plurality of TDM Framers connected to said TDM switching unit;
a plurality of packet Framers connected to said packet router; and
means for selectively connecting said plurality of TDM Framers and packet Framers to separate transmit/receive ports of said optical signal circuitry for different channels,
wherein connections are provided between the corresponding TDM Framers as well as packet Framers of said first and second optical line interface units to forward information received from a node apparatus located upstream on said network formed by the first and second optical rings to a node apparatus located downstream on said network.

8. An integrated packet and TDM switching node apparatus as claimed in claim 7, further comprising selectors for selectively connecting each of a plurality of pairs of transmit/receive ports of said optical signal circuitry to one of said plurality of TDM Framers or packet Framers.

9. An integrated packet and TDM switching node apparatus as claimed in claim 8, further comprising a control unit which controls said selectors for changing the connections between said transmit/receive ports and said TDM Framers as well as said packet Framers.

10. An integrated packet and TDM switching node apparatus as claimed in claim 4, further comprising means for monitoring packet traffic passing across said packet router and TDM traffic passing across said TDM switching unit.

11. An integrated packet and TDM switching node apparatus as claimed in claim 5, further comprising means for monitoring packet traffic passing across said packet router and TDM traffic passing across said TDM switching unit.

12. An integrated packet and TDM switching node apparatus as claimed in claim 6, further comprising means for monitoring packet traffic passing across said packet router and TDM traffic passing across said TDM switching unit.

13. An integrated packet and TDM switching node apparatus as claimed in claim 7, further comprising means for monitoring packet traffic passing across said packet router and TDM traffic passing across said TDM switching unit.

14. An integrated packet and TDM switching node apparatus as claimed in claim 8, further comprising means for monitoring packet traffic passing across said packet router and TDM traffic passing across said TDM switching unit.

15. An integrated packet and TDM switching node apparatus as claimed in claim 9, further comprising means for monitoring packet traffic passing across said packet router and TDM traffic passing across said TDM switching unit.
